(19) United States
(12) Patent Application Publication
(10) Pub. No.: US 2012/0307094 A1
(43) Pub. Date: Dec. 6, 2012

(54) IMAGE FILE DATA STRUCTURE, IMAGE FILE GENERATION DEVICE, IMAGE FILE GENERATION METHOD, AND ELECTRONIC CAMERA

(75) Inventors: Go MIGIYAMA, Kawasaki-shi (JP); Koichi GOHARA, Kawasaki-shi (JP); Hideo HIBINO, Yamato-shi (JP)

(73) Assignee: NIKON CORPORATION, Tokyo (JP)

(21) Appl. No.: 13/587,672

(22) Filed: Aug. 16, 2012

Related U.S. Application Data
(63) Continuation of application No. 12/861,266, filed on Aug. 23, 2010.

(30) Foreign Application Priority Data
Aug. 28, 2009 (JP) 2009-198095

(51) Int. Cl. H04N 5/225

(52) U.S. Cl. 348/220.1; 348/E05.024

(57) ABSTRACT

In an electronic camera that captures still images when capturing a moving image records associated images in a moving image file, the data structure of which includes metadata for both of the moving image and the still images captured when the moving image is being captured. The metadata includes identification data, which unambiguously identifies a still image that is associated with the moving image.

### CROSS-REFERENCE TO RELATED APPLICATIONS

This application is a Continuation of application Ser. No. 12/861,266 filed Aug. 23, 2010, which claims the benefit of priority from prior Japanese Patent Application No. 2009-198095, filed on Aug. 28, 2009, the entire contents of which are incorporated herein by reference.

### BACKGROUND OF THE INVENTION

The present invention relates to a data structure for an image file such as a moving image or a still image, a device and method for generating such an image file, and an electronic camera having an image file generation function.

In the prior art, one type of an electronic camera captures still images while capturing a moving image, generates a data structure including associating data for associating a file for the still images with a file for the moving image, and records (saves) the two image files associated with each other. The associating data includes the file name of the associated image file as an identifier (for example, refer to Japanese Laid-Open Patent Publication number 2004-304425.

### SUMMARY OF THE INVENTION

The file name of an image file may be rewritten by a user. In the electronic camera described in Japanese Laid-Open Patent Publication number 2004-304425, when the file name of one or both of the image files associated with each other by the associating data is rewritten, the rewritten file name would differ from the file name used as the identifier in the associating data. In this case, the associated. moving image and still images cannot be identified due to the file name that is used as the identifier in the associating data

One aspect of the present invention is a data structure for an image file. The data structure includes one of a moving image and a still image, which is captured when the moving image is being captured, and metadata for either one of the images. The metadata includes identification data that unambiguously identifies the other one of images,

Another aspect of the present invention is an image file generation device for generating an image file related with at least either one of a moving image and a still image, which is captured when the moving image is being captured. The image file generation device includes a file generation unit that generates the image file for one of the images by adding metadata to image data of the one of the images. The metadata includes identification data, which unambiguously identifies the other one of the images associated with the one of the images.

A further aspect of the present invention is an electronic camera including a capturing device capable of capturing a moving image and a still image. An image data generation unit generates moving image data of the moving image captured by the capturing device and still image data of the still image captured when the moving image is being captured. The electronic camera further includes the image file generation device described above.

Still another aspect of the present invention is a method for generating an image file related with at least one of a moving image and a still image captured when the moving image is being captured. The method includes generating the image file related with one of the images by adding metadata to image data of the one of the images. The metadata includes identification data that unambiguously identifies the other one of the images associated with the one of the image.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessary achieving other advantages as may be taught or suggested herein.

### BRIEF DESCRIPTION OF THE DRAWINGS

FIG. 1 is a block diagram showing a circuit configuration of a digital camera;

FIG. 2 is a flowchart showing an image file generation processing routine;

FIG. 3 is a schematic diagram of metadata related with a normal still image;

FIGS. 4(a) to 4(d) are schematic diagrams of metadata related with still images associated with a moving image;

FIG. 5 is a schematic diagram of metadata related with a normal moving image;

FIG. 6 is a schematic diagram of metadata related with a moving image associated with a still image;

FIG. 7 is an explanatory diagram showing the contents of a screen on a monitor displaying a moving image;

FIGS. 8(a) and 8(b) are schematic diagrams of metadata related with each associated moving image in a divided moving image file that is obtained by dividing a moving image file; and

FIG. 9 is a schematic diagram of an image file including metadata and image data.

### DETAILED DESCRIPTION OF THE PREFERRED EMBODIMENTS

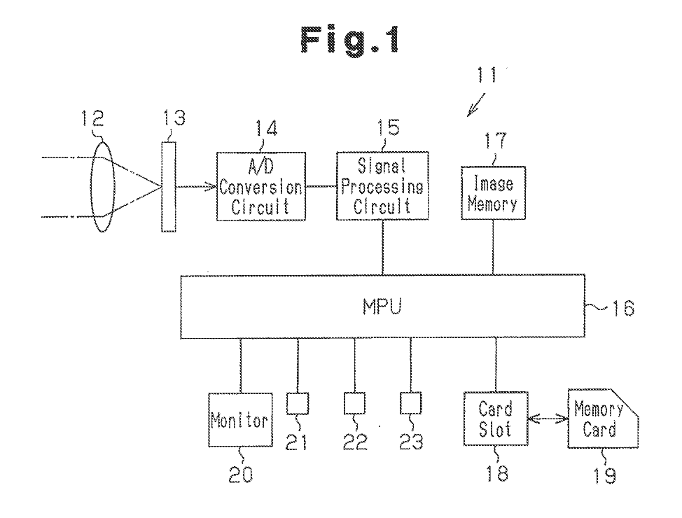

A digital still camera (hereinafter referred to as the “camera”), which is one type of an electronic camera according to one embodiment of the present invention, an image file generation device included in the camera, a data structure for an image file generated by the image file generation device, and a method for generating an image file will now be discussed with reference to FIGS. 1 to 8.

As shown in FIG. 1, a camera 11 has a camera body (not shown) that includes a lens unit 12 and an imaging element 13. The lens unit 12 has a plurality of lenses such as a zoom lens (only one lens is shown in FIG. 1 to simplify the drawing). The imaging element 13 serves as an image capturing device that captures the image of an object by focusing the light from the object passing through the lens unit 12 at an imaging the side of the lens unit 12. The imaging element 13 includes a complementary metal oxide semiconductor (CMOS) image sensor or a charge coupled device (CCD) image sensor. The imaging element 13 stores signal charge corresponding to an image of the object formed on its image capturing plane, generates an analog signal referred to as a pixel signal, and outputs the analog signal.

An A/D conversion circuit 14 and a signal processing circuit 15, which functions as an image data generation unit, are connected in series to the imaging element 13. The A/D conversion circuit 14 converts the pixel signal, which is the analog signal output from the imaging element 13, into a digital signal and provides the digital signal to the signal processing circuit 15. A micro-processing unit (MPU) 16 is arranged in the camera body of the camera 11 to centrally control various operations in the camera 11 based on a control program stored in an ROM (not shown). The MPU 16 provides the signal processing circuit 15 with a various types of control signals which used to generate image data and metadata related with moving images and still images.

Specifically, the signal processing circuit 15 performs various types of image processing on digital pixel signals related with moving images or still images based on the control signal from the MPU 16 to generate predetermined image data. The signal processing circuit 15 also generates metadata including the model name and manufacturing serial number of the camera 11 used to capture the image related with the image data. The image data and metadata generated in such a manner are temporarily recorded to an image memory 17, which functions as a buffer memory connected to the MPU 16. The image data and metadata are further recorded through a card slot 18 to a memory card 19 as an image file in a predetermined format. The memory card 19 is a recording medium that is removable from the camera 11.

Further, as shown in FIG. 1, a monitor 20, a release button 21, a selection button 22, and a live view button 23 are connected to the MPU 16, The monitor 20 functions as a display device, which is capable of displaying a various types of images such as moving images and still images, and may be, for example, a liquid crystal display (LCD). The monitor 20 selectively displays moving images and still images based on display control executed by the MPU 16. The user mainly operates the release button 21 when capturing still images. The user mainly operates the selection button 22, which includes a cursor key and a determine key (neither shown), when switching the screen shown on the monitor 20 or changing various settings (for example, when switching from a still image capture mode to a moving image capture mode). The user operates the live view button 23 to show a live image of an object formed on the image capturing plane of the imaging element 13, as a through-the-lens image, on the monitor 20.

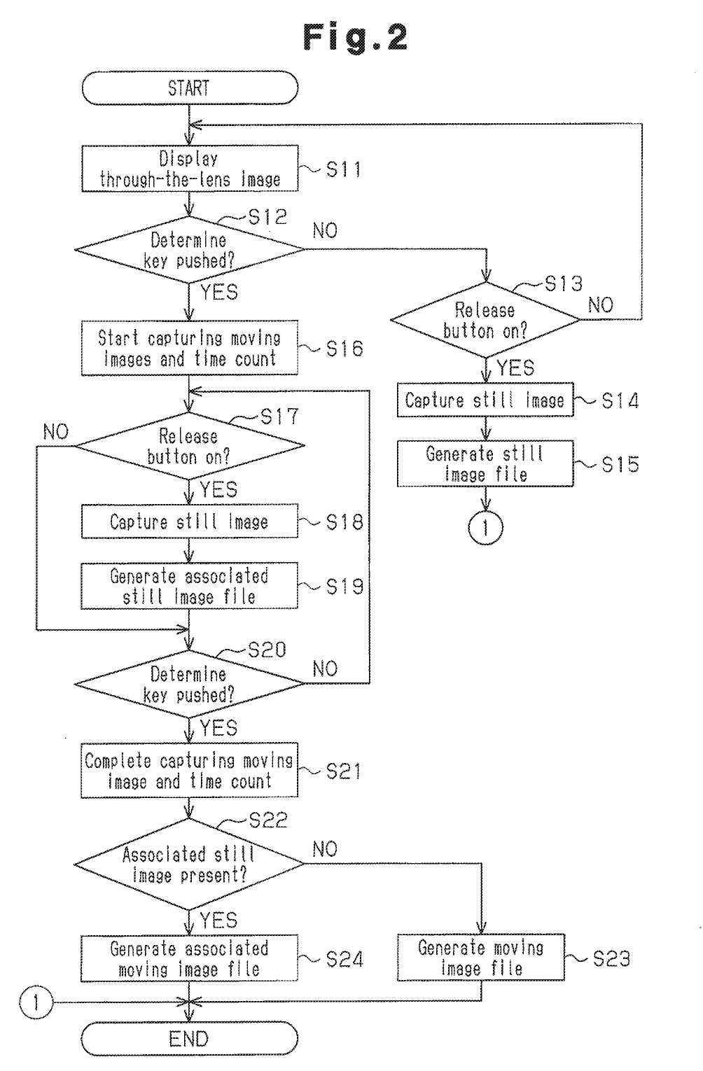

The outline of an image file generation processing routine executed by the MPU 16 in the digital camera 11 will now be discussed with reference to the flowchart of FIG. 2.

In a state in which a power button (not shown) of the camera 11 is turned on, when the live view button 23 is turned on, the MPU 16 starts the image file generation processing routine shown in FIG. 2. In step S11, the MPU 16 displays on the monitor 20 a through-the-lens image, which is the present image of an object formed on the image capturing plane of the imaging element 13 that changes as time elapses. Next, in step S12, the MPU 16 determines whether or not the determine key of the selection button 22 has been pushed by the user. That is, the MPU 16 determines whether or not the user has decided to capture a moving image of the object that is being displayed as the through-the-lens image on the monitor 20,

When the determination of step S12 is negative (NO in step S12), the MPU 16 proceeds to step S13 and determines whether or not the user has turned on the release button 21. That is, the MPU 16 determines whether or not the user has decided to capture a still image of the object that is being displayed as the through-the-lens image on the monitor 20. When the determination of step S13 is negative (NO in step S13), the MPU 16 returns to step S11 and repeats the processing from step S11.

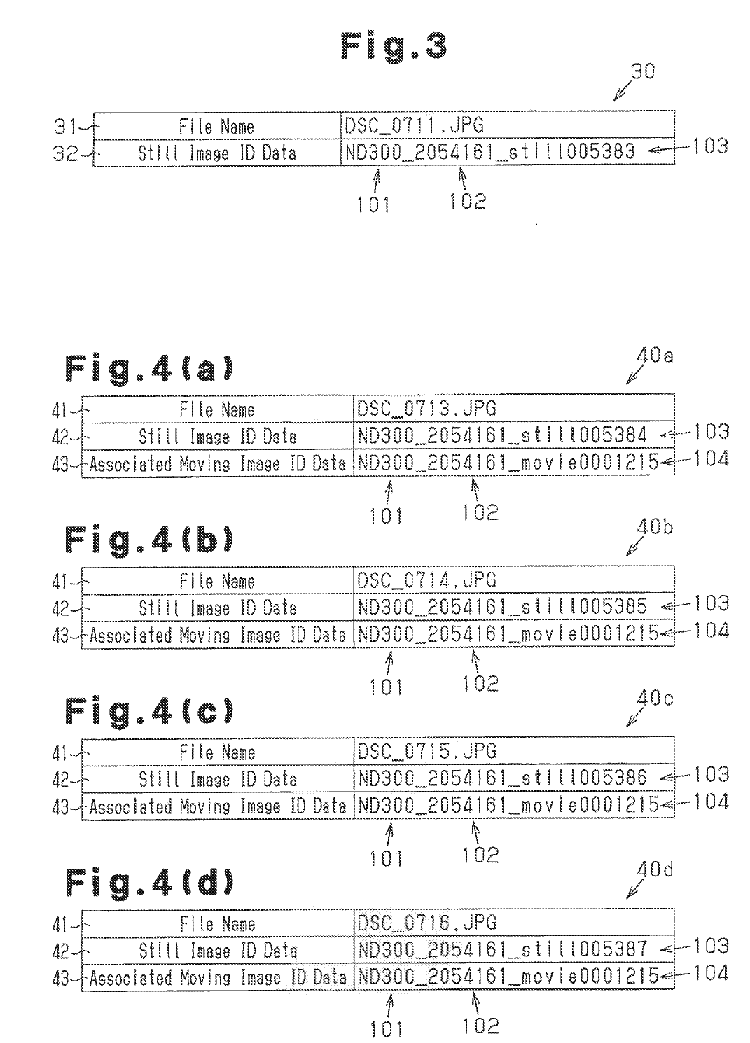

When the determination of step S13 of whether or not the release button 21 has been turned on is affirmative (YES in step S13), the MPU 16 proceeds to step S14 and sets the capture mode of the camera 11 to the still image capture mode to capture a still image of the object presently formed on the image capturing plane of the imaging element 13. That is, in step S14, the MPU 16 provides the signal processing circuit 15 with a control signal for generating image data (still image data) of a still image when the release button 21 is turned on and metadata (see FIG. 3) related with the still image.

The metadata related with still image will now be described. FIGS. 3 and 4 show metadata 30 and 40a to 40d, one of which is generated whenever the camera 11 according to the present embodiment captures a still image.

The metadata 30 shown in FIG. 3 is related with a normal still image, which is captured when a moving image is not being captured (i.e., the still picture is not associated with a moving image), and has a data structure including a file name 31 and still image identification (ID) data 32. In contrast the metadata 40a to 40d shown in FIGS. 4(a) to 4(d) are each related with an associated still image (i.e., the still image is associated with a moving image), which is captured when a moving image is being captured, and has a data structure including a file name 41, still image ID data 42, and associated moving image ID data 43.

In the metadata 30 and 40a to 40d related with still images, the file names 31 and 41 each show the name of a still image file for a still image. The still image ID data 32 and 42 each function as an identifier that unambiguously identifies the corresponding still image from other still images. Further, in the metadata 40a to 40d related with associated still images, the associated moving image ID data 43 functions as an identifier enabling identification, from other moving images, of the moving image that was captured (i.e,, the associated moving image) when the corresponding still image was captured.

The file names 31 and 41 of the still images are managed by a file allocation table (FAT) and may easily be rewritten by the user. This allows for the user to easily rewrite the file names 31 and 41 when necessary and is thus convenient.

In contrast, the descriptions of the still image ID data 32 and 42 and the associated moving image ID data 43 are recorded to a header region of a still image file, for example.

In the illustrated example, the still image ID data 32 and 42 have a data structure including a model name 101 (“ND300”) of the camera 11 used to capture the corresponding still image, a manufacturing serial number 102 (“2054161”) of the camera 11, and a still image number 103 (“sti11005383” etc.) that is incremented whenever a still image is captured by camera 11 and given to the captured still image. The still image number 103, which functions as sequence number data, has a data structure that includes an image type description. of “still”, which indicates that the image corresponding to the ID data is a still image, and a number description (“005383” for the metadata 30), which is formed by a sequence number.

In the same manner, the associated moving image ID data 43 has a data structure including the model name 101 (“ND300”) of the camera 11 used to capture the corresponding moving image, the manufacturing serial number 102 (“2054161”) of the camera 11, and a moving image number 104 (“movie0001215” etc.) that is incremented whenever a moving image is captured by camera 11 and given to the captured moving image. The moving image number 104, which functions as sequence number data, has a data structure that includes an image type description “movie”, which indicates that the image corresponding to the ID data is a moving image, and a number description (“0001215”) , which is formed by a sequence number,

The model name 101, the manufacturing serial number 102, the still image number 103, and the moving image number 104 in the ID data 32, 42, and 43 are data contents that are automatically added, irrelevant of the user's intentions, to the corresponding images when they are captured and cannot be freely selected by the user. Further, the ID data 32, 42, and 43 are used when searching for the image data of a still image and reading the corresponding image data from the memory card 19 to reproduce and display the still image on the monitor 20.

Returning to the description of FIG. 2, when the capturing of a still image in step S14 ends, the MPU 16 proceeds to step S15 and performs a process for generating a normal still image file with the signal processing circuit 15 by adding the metadata 30 shown in FIG. 3 to the image data of the still image captured. in step S14. Then, the MPU 16 records the still image file generated in step S15 to the memory card 19 and ends the image file generation processing routine.

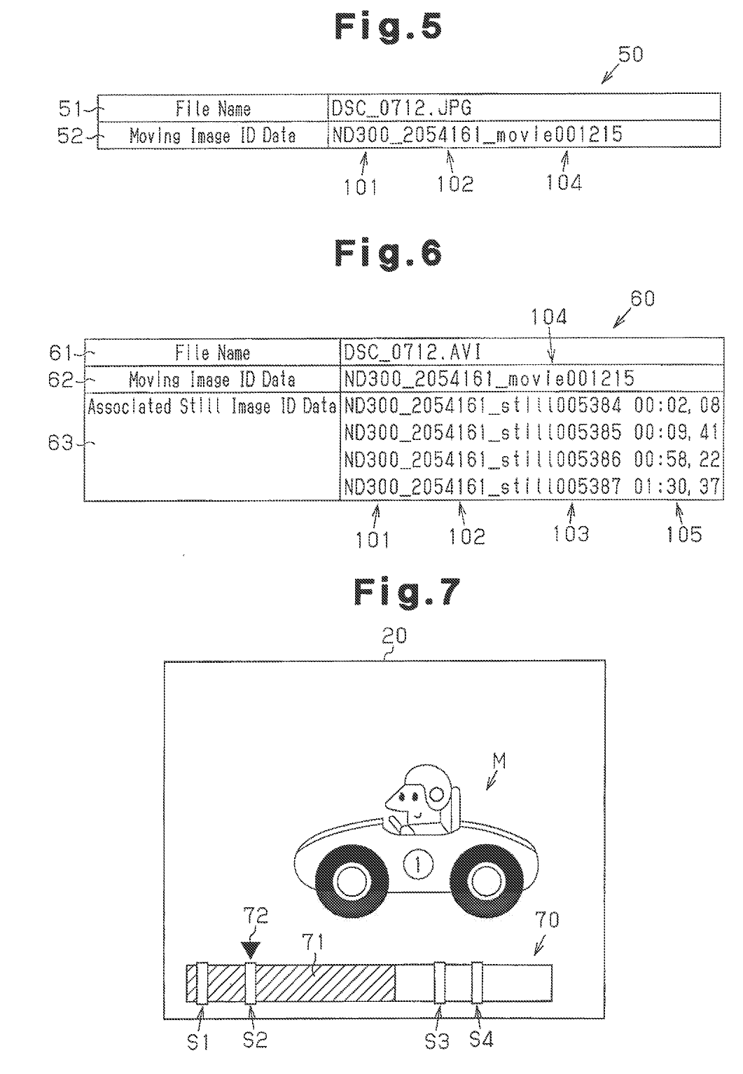

When the determination of step S12 is affirmative (YES in step S12) , the MPU 16 proceeds to step S16 and sets the capture mode of the camera 11 to the moving image capture mode. Further, in step S16, the MPU 16 captures a moving image of the object being shown as the through-the-lens image on the monitor 20. That is, in step S16, the MPU 16 provides the signal processing circuit 15 with a control signal for generating image data (moving image data) and metadata (see FIGS. 5 and 6) related with the moving image. The image data is for a moving image that changes as time elapses from when the determine key of the selection button 22 is pushed.

The metadata related with a moving image will now be described. Whenever the camera 11 according to the present embodiment captures a moving image, either one of metadata 50 and 60 shown in FIGS. 5 and 6 is generated.

First, the metadata 50 shown in FIG. 5 is related with a normal moving image, which is captured without any capturing interruptions of a still image (i.e., a still image that is not associated with the moving image), and has a data structure including a file name 51 and a moving image ID data 52. In contrast, the metadata 60 shown in FIG. 6 is related with an associated moving image, which is captured with a capturing interruption of a still image (i.e., a still image associated with the moving image), and has a data structure including a file name 61, a moving image ID data 62, and an associated still image ID data 63.

In the metadata 50 and 60 related with moving images, the file names 51 and 61 each show the name of a moving image file related with a moving image. The moving image ID data 52 and 62 each function as an identifier unambiguously identifying the corresponding moving image from other moving images. Further, in the metadata 50 related with the associated moving images, the still image ID data 63 functions as an identifier enabling identification, from other still images, of the still image (that is, the associated still image) that was captured as an interruption when capturing the moving image.

In the same manner as the file names of a still image, the file names 51 and 61 of a moving image are managed by the FAT and may easily be rewritten by the user. This allows for the user to easily rewrite the file names 51 and 61 for moving image files when necessary. In contrast, the descriptions of the moving image ID data 52 and 62 and the associated still image ID data 63 are recorded to the header region of a moving image file, for example.

Specifically, in the same manner as the still image ID data 32 and 42, the moving image ID data 52 and 62 have data structures including the model name 101 (“ND300”) of the camera 11 used to capture the corresponding moving image, the manufacturing serial number 102 (“2054161”) of the camera 11, and the moving image number 104 (“movie001215” etc) that is incremented whenever a moving image is captured by camera 11 and given to the captured moving image. The moving image number 104, which functions as sequence number data, has a data structure that includes an image type description “movie”, which indicates that the image corresponding to the ID data is a moving image, and a number description (“0001215”), which is formed by a sequence number.

In the same manner, the associated still image ID data 63 also has a data structure including a model name 101 (“ND300”) of the camera 11 used to capture the corresponding still image, a manufacturing serial number 102 (“2054161”) of the camera 11, and a still image number 103 (“sti11005384” etc.) that is incremented whenever a still image is captured by camera 11 and given to the captured still image. The still image number 103, which functions as sequence number data, has a data structure that includes an image type description “still”, which indicates that the image corresponding to the ID data is a still image, and a number description (“0005384”), which is formed by a sequence number.

In the same manner as the ID data 32, 42, and 43, the model name 101, the manufacturing serial number 102, the still image number 103, and the moving image number 104 in the ID data 52, 62, and 63 are data contents that are automatically added, irrelevant of the user's intentions, to the corresponding images when they are captured and cannot be freely selected by the user. Further, like the ID data 32, 42, and 43, the ID data 52, 62, and 63 are also used when searching for the image data of a moving image and reading the corresponding image data from the memory card 19 to reproduce and display the still image on the monitor 20. Thus, the ID data 52, 62, and 63 including the model name 101, manufacturing serial number 102, still image number 103, and moving image number 104 are written in a non-rewritable data format and thereby differ from the file names 51 and 61.

Returning to the description of FIG. 2, when starting moving image capturing and time count in step S16, the MPU 16 proceeds to step S17 and determines whether or not the release button 21 has been turned on by the user. That is, the MPU 16 determines whether or not the user has determined to capture a still image of the object that is being shown as a through-the-lens image on the monitor 20 while the moving image is being captured. Then, when the determination in step S17 is affirmative (YES in step S17) , the MPU 16 in step S18 provides the signal processing circuit 15 with a control signal for generating image data (associated still image data) of a still image when the release button 21 is turned on and metadata. (see FIG. 4) related with the associated still image.

Then, when the capturing of the associated still image in step S18 ends, the MPU 16 proceeds to step S19 and generates an associated still image file by adding metadata to the image data of the associated still image generated, in step S18 with the signal processing circuit 15. Subsequently, the MPU 16 temporarily records the associated still image file (see FIG. 9) generated in step S19 to the image memory 17, which serves as a buffer memory, and then proceeds to step S20.

Next, in step S20, the MPU 16 determines whether or not the determine key of the selection button 22 has been pushed by the user. In the illustrated camera 11, when the determine key of the selection button 22 is pushed for the first time in step S12 and pushed for the second time in step S20, the second pushing of the determine key is an operation for completing the moving image capture mode. Accordingly, in step S20, the MPU 16 determines whether or not the user has determined to complete the capturing of the moving image.

Then, when the determination of step S20 is negative (NO in step S20), the MPU 16 returns to step S17. The MPU 16 repeats the processing from step S17 again. Further, as long as the determination of step S17 is affirmative (YES in step S17) and the determination of step S20 is negative (NO in step S20), the MPU 16 in step S18 repeatedly captures a plurality of associated still images (four in the present embodiment) while capturing one moving image. Still image files of associated still images repeatedly captured in such a manner are each generated in step S19 and temporarily recorded in the image memory 17.

When the determination of step S17 of whether or not the release button 21 has been pushed is negative (NO in step S17), the MPU 16 proceeds to step S20 and determines whether or not the determine key of the selection button 22 has been pushed by the user, that is, whether or not the user has determined to complete the capturing of the moving image. When the determination of step S20 is affirmative (YES in step S20), the MPU 16 proceeds to step S21 and provides the signal processing circuit 15 or the like with a control signal for completing the moving image capturing and the time count.

Then, in step S22, the MPU 16 determines whether or not there is any associated still image, that is, whether or not any still images have been captured as interrupts during the capturing of the moving image. When the determination is negative (NO in step S22), the MPU 16 proceeds to step S23 and provides the signal processing circuit 15 with a control signal for generating a moving image file by adding the metadata 50 (see FIG. 5) related with the normal moving image to the image data of the moving image captured from when the moving image capturing started in step S16 to when it was completed in step S21.

When the determination of step S22 is affirmative (YES in step S22), the MPU 16 provides the signal processing circuit 15 with a control signal for generating a moving image file by adding the metadata 60 (see FIG. 6) related with the associated moving image to the image data of the moving image that is obtained in the duration from the point in time when the moving image captured from when the moving image capturing started in step 516 to when it was completed in step S21. Then, when the processing of either step S23 or step S24 for generating a moving image file is completed, the MPU 16 ends the image file generation processing routine.

The operation of the camera 11 in the present embodiment will now be discussed. in particular, the generation of image files with moving images and still images when capturing a still image while capturing a moving image will be described.

In the camera 11 of the present embodiment, when the user pushes the live view button 23, a through-the-lens image, which changes as time elapses, of an object that is presently formed on the image capturing plane of the imaging element 13 is shown on the monitor 20. In this state, when the release button 21 is turned on, the capture mode is set to the still image capture mode to capture a still image. Then, the metadata 30 shown in FIG. 3 is added to the image data of the object image presently currently formed on the image capturing plane of the imaging element 13 to generate a still image file related with a normal still image. The still image file is recorded to the memory card 19.

In a state in which the through-the-lens image is being shown on the monitor 20, when the user pushes the determine key of the selection button 22 instead of turning on the release button 21, the capture mode is set to the moving image capture mode. This starts the capturing of a moving image. Further, the measurement of the elapsed time from when the moving image capturing starts (time count) is also started.

When the determine key of the selection button 22 is pushed again without the release button 21 being turned on after the moving image capturing is started, the moving image capturing is completed. Then, the metadata 50 shown in FIG. 5 is added to the image data of the moving image captured from when moving image capturing was started to when it was completed to generate a moving image file related with an normal moving image. The moving image file is recorded to the memory card 19,

When the release button 21 is turned on during the period from when the moving image capturing is started to when the determine key of the selection button 22 is pushed again, whenever the release button 21 is turned on, an associated still image is captured in interrupts and associated with the moving image that is being captured. Then, whenever such a capturing interrupt is performed, the metadata 40a to 40d related to associated still images shown in FIGS. 4(a) to 4(d) is added to the image data of the still image to generate an associated still image file (see FIG. 9). The associated still image file is recorded to the memory card 19.

When such associated still images are captured in interrupts as a moving image is being captured, the capturing of the moving image is completed by pushing the determine key of the selection button 22 again. Then, the metadata 60 shown in FIG. 6 is added to the image data of the moving image captured from when moving image capturing was started to when it was completed to generate a moving image file related with the associated moving images (see FIG. 9). The moving image file is then recorded to the memory card 19.

In a state in which a still image file and moving image file generated as described above is recorded to the memory card 19, when reproducing and displaying a moving image or still image on the monitor 20, the user selects the image file that he or she wishes to reproduce and display from uhe image files shown on a selection screen (not shown) by operating the selection button 22.

For example, when a moving image file related with an associated moving image including the metadata 60 shown in FIG. 6 is selected for reproduction, a moving image M shown in FIG. 7 is shown on the monitor 20. In a lower region of the monitor 20, a moving image display bar 70 is shown. The moving image display bar 70 includes a colored progress display portion 71, which indicates the reproduction progress rate of the moving image M and advances from left to right as the reproduction of the moving image M progresses. In FIG. 7, the moving image display bar 70 includes four still image marks S1 to S4, which indicate that four associated still images have been captured. in interrupts when the moving image M was being captured.

The still image marks S1 to S4 are each shown at positions corresponding to the data contents of the data of a capture time 105 for the associated still image. The capture time 105 is included in the associated still image ID data 63 of the metadata 60 related with the moving image N, which is being reproduced and displayed. In the illustrated example, when a cursor 72 is moved to the position of any one of the still image marks Si to S4 by operating the selection button 22 and the determine key is pushed at that position, the associated still image corresponding to the still image mark is enlarged and shown on the monitor 20. This allows for the user to view the associated still image with a clear image quality and check one image that was formed when capturing the moving image M.

In this case, for example, when the determine key of the selection button 22 is pushed with the cursor 72 located at the position of the first still image mark S1, the MPU 16 searches the memory card 19 for the corresponding still image file. In the associated still image ID data 63 (“ND300_{—}2054161_st111005384 00:02,08”) of the metadata 60 shown in FIG. 6, a refined search may be performed for the first associated still image by using a common data portion (“ND300_{—}2054161”) as a search key. After performing such a refined search, a further search may be performed using a unique data portion (“sti11005384 00:02,08”) as a search key. This would allow for the still image file of the first associated still image having a data structure including the metadata 40a shown in FIG. 4(a) to be efficiently searched.

The user may rewrite the file name 41 “DSC_{—}0713.JPG” of the still image file for the first associated still image having a data structure including the metadata 40a shown in FIG. 4(a). However, even in such a case, the associated still image ID data 42 used in a search is in a non-rewritable data format This avoids a situation in which the still image file of the first associated still image cannot be found,

In the moving image M shown in FIG. 7, a long time of 58.22 seconds is required for the moving image M to reach the position of the third still image mark S3 from when its reproduction and display starts. In such a case, the moving image file related with an associated moving image including the metadata 60 shown in FIG. 6 may be divided into a plurality of (two in the case of the present embodiment) divisional files. In this case, the MPU 16 functions as a file division unit and provides the signal processing circuit 15 with a control signal for file division.

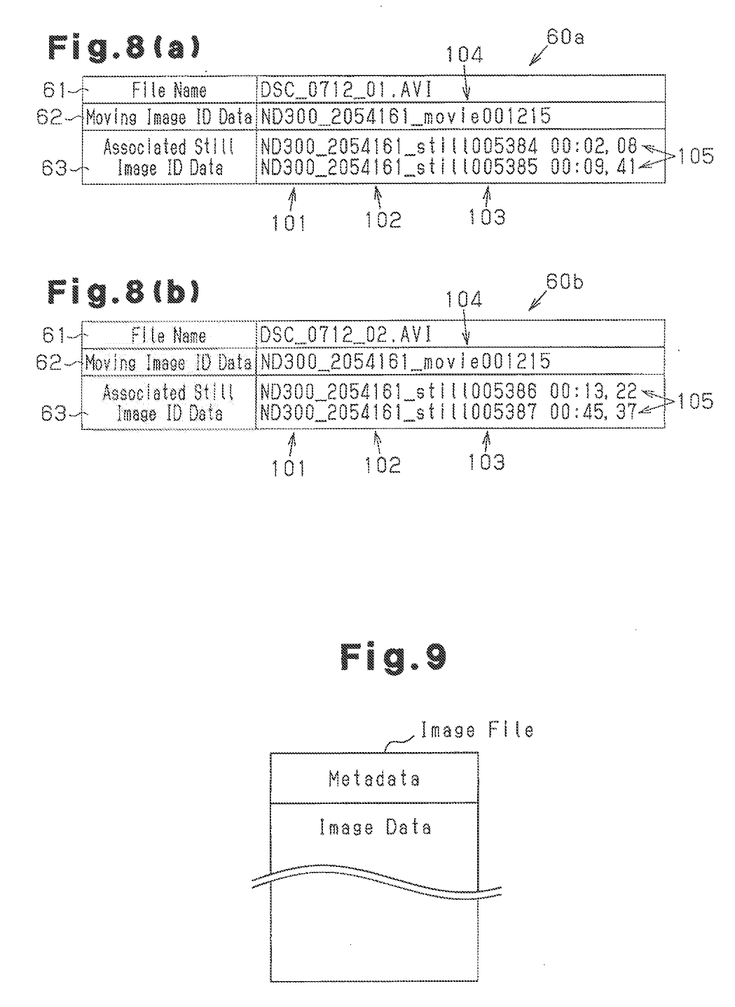

In such a case, as shown in FIG. 8, in the metadata 60a and 60b included in each of the divisional files excluding the one that comes first in chronological order, the capture time 105 for each still image is rewritten and changed. For example, when the moving image file for the moving image M is divided at a time point in which 45 seconds elapses from the capturing starting time, as shown in FIG. 8(b), each capture time 105 in the metadata 60b related with associated still images in divisional files excluding the first divisional file is rewritten and advanced by 45 seconds. In this manner, each capture time 105 is rewritten to indicate the elapsed time from when the moving image of the divisional file, which includes the corresponding associated still image, starts reproduction.

The present embodiment has the advantages described below.

(1) The file names 31, 41, 51, and 61 of still image files and moving image files recorded in a state associated with one another may be rewritten by the user. However, even is such a case, the ID data 42, 43, 52, 62, and 63, used when searching for a corresponding associated image file are recorded as metadata. Accordingly, even when the file names 31, 41, 51, and 61 of image files are rewritten, corresponding image files may be easily and accurately identified. This avoids a situation in which a corresponding image file cannot be found.

(2) When searching for corresponding image files by using the ID data 32, 42, 43, 52, 62, and 63 as search keys, a refined search is first performed using the model name 101 and manufacturing serial number 102, which are the common data portions used in both images. Then, a. final, search is performed using the still image number 103 or moving image number 104, which are the unique data portions found only for the corresponding image, which is the search target. This improves the search efficiency.

(3) The still image number 103 and the moving image number 104, which serve as the unique data portion in the ID data 32, 42, 43, 52, 62, and 63, are sequence numbers incremented whenever an image is captured and automatically added to the image. This ensures the reliability for unambiguously identifying a corresponding image.

(4) The metadata 60 of an associated moving image in which still images were captured in interrupts when the moving image was being captured includes the capture time 105 of each associated still image indicating the elapsed time from when the capturing of the moving image started. This allows for the still image marks S1 to S4 to be shown at different positions in correspondence with each capturing time on the moving image display bar 70, which is superimposed on the moving image reproduced and displayed on the monitor 20.

(5) When the reproduction time of the moving image M is long and the moving image file related with the moving image M is divided, the capture time 105 of each still image in the divisional files excluding the chronologically first divisional file may be rewritten so that it is advanced. This would allow for the still image marks (for example, 63 and 64) of associated still images to be shown in the progress display portion 71 at an earlier timing when the reproduction starts.

It should be apparent to those skilled in the art that the present invention may be embodied in many other specific forms without departing from the scope of the invention. Particularly, it should be understood that the present invention may be embodied in the following forms.

In the above-discussed embodiment, when the camera 11 does not include the live view button 23, the monitor 20 may show a through-the-lens image from when the power button (not shown) is turned on.

In the above-discussed embodiment, in the metadata 60 related with associated moving images, the associated still image ID data 6:3 does not have to include the capture time 105.

In the above-discussed embodiment, the data portion in each of the ID data 32, 42, 43, 52, 62, and 63 may include only the unique data portion of the still image number 103 and the moving image number 104.

In the above-discussed embodiment, the data contents of the ID data 32, 42, 43, 52, 62, and 63 may further include the file name of the corresponding image file in the unique data portion.

In the above-discussed embodiment, the metadata of an image file (still image file, moving image file) includes the file name of the image file. However, the file name of an image file does not have to be included in. the metadata.

In the above-discussed embodiment, the file generation device captures a still image when moving images are being captured. In this state, when the resolution of the still image data recorded while the moving images are being captured is increased to be greater than the resolution of the moving images, the file generation device temporarily stops capturing moving images and captures a still image. This would produce a section in which moving images are not captured from when the capturing of moving images is temporarily stopped to when the capturing of moving images is restarted. Thus, the moving image data would be separated into two parts. To avoid such a situation, the file generation device may use the frame taken immediately before temporarily stopping the capturing of moving images and connect it with the moving image data taken after restarting the capturing of moving images.

In the above-discussed embodiment, the file generation device may use the same resolution for the moving image data and the still image data.. In such a case, the file generation device may retrieve a frame of the moving image data upon receipt of an instruction from a user and generate a still image file.

When the MPU 16 instructs the signal processing circuit 15 to generate image data and metadata, a group of the MPU 16 and the signal processing circuit 15 is one example of a file generation device, and the signal processing circuit 15 is one example of a file generation unit.

The signal processing circuit 15 may generate image data but not the metadata. In this case, the MPU 16 may generate the metadata and add the metadata to an image file to generate an image file for a still image and a moving image. In this case, a group of the MPU 16 and the signal processing circuit 15 is one example of a file generation device, and the MPU 16 is one example of a file generation unit.

The MPU 16 and the signal processing circuit 15 do not have to be discrete and may be formed integrated with each other. In this case, the integrated signal processing circuit 15 and MPU 16 function as an image data generation unit and a file generation unit.

The common data portion and unique data portion in the rnetadata are not limited in any manner and may each be a string of characters or binary data corresponding to a string of characters.

The present examples and embodiments are to be considered as illustrative and not restrictive, and the invention is not to be limited to the details given herein, but may be modified within the scope and equivalence of the appended claims.

What is claimed is:

1. A data structure for an image file, the data structure comprising:
one of a moving image and a still image captured when the moving image is being captured; and
metadata for either one of the images, the metadata including identification data that unambiguously identifies the other one of images.

2. The data structure according to claim 1, wherein the identification data includes:
a common data portion that is common in both of the one of the images and the other one of the images; and
a unique data portion having a data content that is unique to the other one of the images.

3. The data structure according to claim 2, wherein the one of the images is the moving image, the other one of the images is the still image, and the unique data portion of the identification data includes sequence number data that is incremented whenever a still image is captured when the moving image is being captured and added to the still image.

4. The data structure according to claim 1, wherein the image file is a moving image file, the one of the images is the moving image, the other one of the images is the still image, and the identification. data in the metadata includes a capture time of the still image indicating elapsed time from when the capturing of the moving image started.

5. The data structure according to claim 2, wherein the metadata further includes identification data that identifies the one of the images and has the common data portion and the unique data portion, which has a data content that is unique to the one of the images.

6. A moving image file data structure comprising:
moving image data; and
metadata for the moving image data, the metadata including:
moving image identification data that unambiguously identifies the moving image; and
associated still image identification data that unambiguously identifies a still image captured when the moving image was being captured.

7. A still image file data structure comprising:
still image data of a still image captured when a moving image is captured; and
metadata for the still image data, the metadata including:
still image identification data that unambiguously identifies the still image; and
associated moving image identification data that unambiguously identifies the moving image.

8. An image file generation device for generating an image file related with at least either one of a moving image and a still image, which is captured when the moving image is being captured, the image file generation device comprising:
a file generation unit that generates the image file for one of the images by adding metadata to image data of the one of the images, the metadata including identification data, which unambiguously identifies the other one of the images associated with the one of the images.

9. The image file generation device according to claim 8, wherein the file generation unit generates the identification data including a common data portion, which is common in both of the one of the image and the other one of the images, and a unique data portion having a data content unique to the other one of the images.

10. The image file generation device according to claim 9, wherein the one of the images is the moving image, the other one of the images is the still image, and the file generation unit generates the unique data portion including sequence number data that is incremented whenever a still image is captured when the moving image is being captured and added to the still image.

11. The image file generation device according to claim 8, wherein the image file is a moving image file, the one of the images is the moving image, and the other one of the images is the still image; and
the file generation unit generates the identification data including a capture time of the still image indicating elapsed time from when the capturing of the moving image started.

12. The image file generation device according to claim 11, further comprising:
a file division unit that generates a plurality of divisional files by dividing the moving image file generated by the file generation unit, wherein when a plurality of still images are captured at different capture times when a moving image related with the moving image file is being captured, the file division unit rewrites data related to the capture time of each still image in the divisional files excluding the chronologically first one of the divisional files so as to indicate an elapsed time from when reproduction of a divided moving image corresponding to the divisional file including the still image starts.

13. An electronic camera comprising:
a capturing device capable of capturing a moving image and a still image;
an image data generation unit that generates moving image data of the moving image captured by the capturing device and still image data of the still image captured when the moving image is being captured; and
the image file generation device according to claim 8.

14. A method for generating an image file related with at least one of a moving image and a still image captured when the moving image is being captured, the method comprising:
generating the image file related with one of the images by adding metadata to image data of the one of the images, the metadata including identification data that unambiguously identifies the other one of the images associated with the one of the image.
